(19) United States
(12) Patent Application Publication
(10) Pub. No.: US 2014/0018274 A1
(43) Pub. Date: Jan. 16, 2014

(54) Industrial Chemicals

(71) Applicants: Ronald Glynn Fisher, Saint Martinville, LA (US); Karin Marie Stevens Fisher, Saint Martinville, LA (US)

(72) Inventors: Ronald Glynn Fisher, Saint Martinville, LA (US); Karin Marie Stevens Fisher, Saint Martinville, LA (US)

(21) Appl. No.: 13/779,391

(22) Filed: Feb. 27, 2013

Related U.S. Application Data
(60) Provisional application No. 61/603,737, filed on Feb. 27, 2012.

(51) Int. Cl. C11D 7/50

(52) U.S. Cl. CPC C11D 7/50
USPC 510/109

(57) ABSTRACT

The chemical solvent disclosed includes a means for cleaning and maintaining industrial process components including one or more of a valve, a pump, a pipeline, and a drilling system.

The present invention relates generally to industrial chemicals, and in one specific though non-limiting embodiment to a complete line of environmentally friendly cleaners, solvents and co-solvents useful in connection with a wide variety of industrial concerns. Many other useful compounds and compositions are also presently contemplated.

Many previous attempts have been made to manufacture and distribute environmentally friendly means for cleaning and maintaining industrial process components, e.g., valves, pumps, pipelines, drilling systems, etc. Such efforts have generally been narrowly targeted, however, with new product lines becoming available only after great delay and significant investment and expense by the user to determine which chemical properties are most helpful in a given operational environment, and then working backward to determine whether a resulting chemical composition can be made in a more environmentally friendly manner.

In contrast, in one example embodiment the current inventors' deep knowledge of interrelated chemical processes and their effects within specified industrial environments led to creation of a broad line of chemical compositions proven useful in application, and prepared with foresight regarding subsequent environmental disposition.

As seen in the supplemental listing of non-exhaustive chemical products filed concurrently herewith (the entirety of which is hereby incorporated by reference), the inventors have conceived and reduced to practice a great many other familial and stand-alone lines of innovative, effective compositions generally useful in the fields and manner specified therein.

That said, the foregoing description and incorporated supplemental materials filed together herewith are provided for illustrative purposes only, and are not intended to describe all possible aspects of the present invention. Moreover, while several exemplary embodiments are described herein, those of ordinary skill in the pertinent arts will appreciate that changes to the description, and various other modifications, omissions and additions may also be made without departing from either the spirit or scope thereof.

1. A chemical solvent, said solvent comprising:
means for cleaning and maintaining industrial process components, wherein said components include one or more of a valve, a pump, a pipeline, and a drilling system.
